(19) United States
(12) Patent Application Publication
(10) Pub. No.: US 2003/0129910 A1
(43) Pub. Date: Jul. 10, 2003

(54) Multiple-layered nonwoven constructs for improved barrier performance

(76) Inventor: John Norton, Indian Trail, NC (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/280,331

(22) Filed: Oct. 25, 2002

Related U.S. Application Data
(60) Provisional application No. 60/339,605, filed on Oct. 26, 2001.

(51) Int. Cl. B32B 21/02; B32B 5/26; B32B 27/02; D04H 5/06

(52) U.S. Cl. 442/385; 442/382; 442/389; 442/392; 442/394; 442/400; 442/401; 442/409

(57) ABSTRACT

The present invention is directed to a nonwoven laminate fabric comprising at least two layers of light-weight SBS or SBBS fabrics, where B represents a barrier layer, said layers being bonded together to form a laminate fabric. The bonding methods can include thermal calendering, thermal point bonding, ultrasonic bonding, flat calendaring, and adhesive bond. The barrier layer comprises a material selected from suitable media, such media include: meltblown, cellulosic pulp, microporous film or monolithic film, with microfiber media such as meltblown being preferred.

### TECHNICAL FIELD

The present invention relates generally to a method of laminating together spunbond-meltblown-spunbond composite fabrics to make improved barrier fabrics. Nonwoven fabrics embodying the present invention exhibit unique performance attributes, particularly with regard to air permeability and moisture-vapor transport performance.

### BACKGROUND OF THE INVENTION

Nonwoven fabrics are used in a wide variety of applications where the engineered qualities of the fabrics can be advantageously employed. The use of selected thermoplastic polymers in the construction of the fibrous fabric component, selected treatment of the fibrous component (either while in fibrous form or while in an integrated structure), and selected use of various mechanisms by which the fibrous component is integrated into a useful fabric, are typical variables by which to adjust and alter the performance of the resultant nonwoven fabric.

In and of themselves, continuous filament fabrics are relatively highly porous, and ordinarily require an additional component in order to achieve the required barrier performance. Typically, barrier performance has been enhanced by the use of a barrier “melt-blown” layer of very fine filaments, which are drawn and fragmented by a high velocity air stream, and deposited into a self-annealing mass. Typically, such a melt-blown layer exhibits very low porosity, enhancing the barrier properties of composite fabrics formed with spunbond and melt-blown layers.

Conventional spunbond/melt-blown/spunbond (SMS)-type fabrics for protective apparel are manufactured in a basis weight range of 45-60 grams per square meter, typically relying upon a melt-blown layer of more than 10 grams per square meter, to provide the desired barrier function. Ordinarily, these types of fabrics have a hydrostatic head rating of greater than 45 centimeters, before the addition or topical treatment of the constructs with alcohol resistant and anti-static chemistries.

Further prior art improvements on the SMS construct have been made by incorporating multiple light-weight meltblown barrier layers, i.e., SMMS fabrics, in lieu of single heavy-weight meltblown layers. Fabrication in this manner has been found to reduce hydrostatic head failures, which can otherwise result due to defects that are common in melt-blown fabrics; the plural melt-blown layers compensate for defects, which may exist in any one layer. While multiple melt-blown layers act to facilitate manufacturing efficiency, the complexity of such a process requires additional equipment for each subsequent layer.

U.S. Pat. No. 5,464,688 teaches the use of modified polypropylene resin with a higher melt flow rate to produce a meltblown web having average fiber diameters of from 1 to 3 microns and pore sizes distributed in the range from 7 to 12 microns compared to previously reported meltblown webs, which have pore sizes distributed predominantly in the range from 10 to 15 microns.

U.S. Pat. No. 5,482,765 teaches the addition of fluorocarbons to either the meltblown or spunbond layer and a meltblown layer with between 5 and 20% polybutylene. Such modifications provide a laminate having improved barrier and strength to weight ratios. The enhancement is measured by the ratio of hydrostatic head to meltblown layer basis weight of greater than 115 cm/osy (3.38 cm/gsm).

Barrier properties can also be improved by laminating a barrier film onto a nonwoven fabric, either by using an adhesive between the layers, or by extrusion coating of a film onto the fabric to obtain a thermal bond. Vapor breathable films, such as microporous or monolithic films, can be used to improve comfort, but still maintain sufficient barrier property.

The present invention contemplates bonding together multiple layers of lightweight nonwoven materials such as SMS or SMMS through known bonding techniques to form a higher weight fabric with improved barrier properties. Particularly, fabrics of the present invention exhibit greater air permeability than single laminate fabrics of the same basis weight. Present commercial uses for such fabrics include protective clothing, covers, barrier fabrics for buildings and the like, other garments, such as hospital gowns, rain wear and outer covers for disposable absorbent garments such as diapers and the like.

### SUMMARY OF THE INVENTION

The present invention is directed to a nonwoven laminate fabric comprising at least two layers of light-weight SBS or SBBS fabrics, where B represents a barrier layer, said layers being bonded together to form a laminate fabric. The bonding methods can include thermal calendering, thermal point bonding, ultrasonic bonding, flat calendaring, and adhesive bond.

The thermoplastic polymers of the continuous filament spunbond layer or layers are chosen from the group consisting of polyolefins, polyamides, and polyesters, wherein the polyolefins are chosen from the group consisting of polypropylene, polyethylene, and combinations thereof. It is within the purview of the present invention that the continuous filament spunbond layer or layers may comprise either the same or different thermoplastic polymers. Further, the continuous filaments of the spunbond layer or layers may comprise homogeneous, bicomponent, and/or multi-component profiles and the blends thereof.

The barrier layer comprises a material selected from suitable media, such media include: meltblown, cellulosic pulp, microporous film or monolithic film, with microfiber media such as meltblown being preferred. The thermoplastic polymers of the meltblown microfibers are chosen from the group consisting of polyolefins, polyamides, and polyesters, wherein the polyolefins are chosen from the group consisting of polypropylene, polyethylene, and combinations thereof. It is within the purview of the present invention that the microfibers may comprise either the same or different thermoplastic polymers. Further, the microfibers may comprise homogeneous, bicomponent, and/or multi-component profiles and the blends thereof. The meltblown layer is in the basis weight range of less than or equal to about 10 grams per square meter, the basis weight of between 1 and 5 grams per square meter being most preferred.

Formation of multi-layered fabrics from laminate layers has been found to provide enhanced barrier properties, improved air permeability, and comparable moisture vapor transfer rates (MVTR) when compared to single laminate layers of overall comparable basis weight. Fabrics made according to the present invention would be useful in such applications as personal protective apparel, filtration media, and industrial protective fabrics.

It is further envisioned that chemical additives may be incorporated into or onto the fibers of the spunbond or meltblown layers. These chemical additives can be used to affect such properties as static charge dissipation, flame retardancy, stability to ultra-violet light, hydrophilicity, repellency, and softness.

Other features and advantages of the present invention will become readily apparent from the following detailed description, the accompanying drawings, and the appended claims.

### DETAILED DESCRIPTION

While the present invention is susceptible of embodiment in various forms, there will hereinafter be described, presently preferred embodiments, with the understanding that the present disclosure is to be considered as an exemplification of the invention, and is not intended to limit the invention to the specific embodiments disclosed herein.

A spunbond process involves supplying a molten polymer, which is then extruded under pressure through a large number of orifices in a plate known as a spinneret or die. The resulting continuous filaments are quenched and drawn by any of a number of methods, such as slot draw systems, attenuator guns, or Godet rolls. The continuous filaments are collected as a loose web upon a moving foraminous surface, such as a wire mesh conveyor belt. When more than one spinneret is used in line for the purpose of forming a multi-layered fabric, the subsequent webs is collected upon the uppermost surface of the previously formed web. The web is then at least temporarily consolidated, usually by means involving heat and pressure, such as by thermal point bonding. Using this bonding means, the web or layers of webs are passed between two hot metal rolls, one of which has an embossed pattern to impart and achieve the desired degree of point bonding, usually on the order of 10 to 40 percent of the overall surface area being so bonded.

The thermoplastic polymers of the continuous filament spunbond layer or layers are chosen from the group consisting of polyolefins, polyamides, and polyesters, wherein the polyolefins are chosen from the group consisting of polypropylene, polyethylene, and combinations thereof. It is within the purview of the present invention that the continuous filament spunbond layer or layers may comprise either the same or different thermoplastic polymers. Further, the continuous filaments of the spunbond layer or layers may comprise homogeneous, bicomponent, and/or multi-component profiles and the blends thereof.

The barrier layer comprises a fibrous material selected from suitable media, such media include: meltblown, cellulosic pulp, microporous film or monolithic film with microfiber media such as meltblown being preferred. Cellulosic pulp barrier layers are well-known for providing a useful barrier performance in medical applications and include such materials as wood pulp, in either a wetlaid tissue form or as an airlaid fibrous layer. Suitable microporous film barrier layer can include materials such as those reported in U.S. Pat. No. 5,910,225 herein incoporated by reference, in which pore-nucleating agents are used to form the micropores. Monolithic films as reported in U.S. Pat. No. 6,191,221, herein incorporated by reference, can also be utilized as a suitable barrier means.

A preferred mechanism for forming a barrier layer is through application of the meltblown process. The melt-blown process is a related means to the spunbond process for forming a layer of a nonwoven fabric, wherein, a molten polymer is extruded under pressure through orifices in a spinneret or die. High velocity air impinges upon and entrains the filaments as they exit the die. The energy of this step is such that the formed filaments are greatly reduced in diameter and are fractured so that microfibers of finite length are produced. This differs from the spunbond process whereby the continuity of the filaments is preserved. The process to form either a single layer or a multiple-layer fabric is continuous, that is, the process steps are uninterrupted from extrusion of the filaments to form the first and subsequent layers through consolidation of the layers to form a composite fabric.

Typically higher basis weight SMMS materials are made by increasing the basis weight of each individual layer before bonding the layers together to form the composite fabric. The present invention contemplates forming lightweight layers (one-third or less of the desired final weight) of SMS or SMMS composite fabrics, and then bonding the fabrics together to form a laminate fabric by means of thermal or adhesive bonding. The aforementioned laminate comprising at least two SMS or SMMS composite fabrics. These laminate fabrics have improved air permeability and filtration efficiency compared to the typical SMMS material.

The fabrics of the present invention are suitable for various hygiene, medical, and industrial applications such as protective clothing, covers, barrier fabrics for buildings and the like, other garments, such as hospital gowns, rain wear and outer covers for disposable absorbent garments such as diapers and the like.

### EXAMPLES

Example 1 is a conventional SMMS fabric comprising a spunbond layer basis weight being 17.5 gsm and a meltblown basis weight being 7.5 gsm. This construct was made in accordance with standard practices as applied to equipment supplied by Reifenhauser GmbH for the formation of fabric by thermal point bonding. A thermoplastic resin for the spunbond layers was provided in the form of Exxon 3155 polypropylene. A thermoplastic resin for the meltblown layer was provided in the form of Exxon 3546 polypropylene.

Example 2 is a laminate fabric made in accordance with the present invention, comprising three SMMS composite fabrics, which have been bonded together. The construction of each composite fabric layer comprises 6 gsm of spunbond and 1.5 gsm of meltblown to give a composite fabric of 15 gsm. The composite fabric was made in accordance with standard practices as applied to equipment supplied by Reifenhauser GmbH for the formation of fabric by thermal point bonding. A thermoplastic resin for the spunbond layers was provided in the form of Exxon 3155 polypropylene. A thermoplastic resin for the meltblown layer was provided in the form of Exxon 3546 polypropylene. Three layers of the composite fabric were bonded together by utilization of ultrasonic bonding. The total weight for the formed three-ply laminate fabric is 44 gsm.

Example 3 is an SMS fabric made in accordance with the present invention, comprising a spunbond layer basis weight being 6.5 gsm and a meltblown basis weight being 3 gsm to give a composite fabric of 16 gsm. This construct was made in accordance with standard practices as applied to equipment supplied by Reifenhauser GmbH for the formation of fabric by thermal point bonding. A thermoplastic resin for the spunbond layers was provided in the form of Exxon 3155 polypropylene. A thermoplastic resin for the meltblown layer was provided in the form of Exxon 3546 polypropylene. Three layers of the composite fabric were bonded together by utilization of ultrasonic bonding. The total weight for the formed three-ply laminate fabric is 48.5 gsm.

For comparison purposes, other barrier fabrics from the U.S. patent literature are also included in Table 1. Comparative sample A is a coverall made from unwashed Tyvek® material obtained from Cellucap Melco under product number 5802. Comparative sample B is Kleenguard® material available from Kimberly-Clark Corporation under product number 49103.

Tables 1 and 2 set forth laminate fabrics formed in accordance with the present invention compared to a conventional SMMS fabric and the Comparative Examples. The physical data are presented in Table 1. The materials made in accordance with the present invention, Examples 2 and 3, exhibit adequate physical properties making them suitable for use in durable protective garments or protective fabrics.

In Table 2, the air permeability, the MVTR, and the hydrostatic head performance have been normalized to the material basis weight. Examples 2 and 3 show much higher normalized air permeability compared to Example 1, and Comparative Examples A and B. However, comparison of the normalized MVTR performance of Examples 2 and 3 with Example 1 and Comparative Examples 2 and 3 show similar performance. This should lead to improved comfort when these materials are used in protective apparel. The filtration efficiency of Examples 2 and 3 is significantly greater than that observed for the heavyweight SMMS material of Example 1 and Comparative Example B.

It is reasonably anticipated that materials made in accordance with this invention would show improved performance with regard to the release of fewer particles from the fabric. Materials that release fewer particles while exhibiting adequate barrier performance would be desirable for use in clean room applications.

From the foregoing, numerous modifications and variations can be effected without departing from the true spirit and scope of the novel concept of the present invention. It is to be understood that no limitation with respect to the specific embodiments disclosed herein is intended or should be inferred. The disclosure is intended to cover, by the appended claims, all such modifications as fall within the scope of the claims.

TABLE 1

| | | | | | Kleenguard ® |
|---|---|---|---|---|---|
| | | SMMS | SMS | Tyvek ® | (Kimberly |
| | | (3 ply) | (3 ply) | (Dupont) | Clark) |
| | SMMS | 10A | 15J | Comparative | Comparative |
| | Example 1 | Example 2 | Example 3 | Example A | Example B |
| Basis Wt. (g/m²) | 50 | 44.1 | 48.5 | 45 | 50 |
| Layer weights (g/m²) | 17.5/7.5/7.5/17.5 | 6/1.5/1.5/6 | 6.5/3/6.5 | NA | NA |
| Tensile Strength MD (lb/in) | 36.0 | 27 | 33 | 26.8 | 29.8 |
| Tensile Strength CD (lb/in) | 21.0 | 20 | 20 | 22.1 | 22.2 |
| Elongation MD (%) | 82.3 | 46 | 56 | 25.1 | 27.2 |
| Elongation CD (%) | 100.0 | 73 | 87 | 20.0 | 54.2 |
| Trap Tear MD (lb/in) | 19.1 | 10 | 15 | 7.5 | 10.2 |
| Trap tear CD (lb/in) | 10.3 | 6.4 | 8 | 7.0 | 5.8 |
| Bursting Strength (psi) | 32.0 | 38 | 41 | 57.6 | 26.6 |

TABLE 2

| | | | | Comparative | Comparative |
|---|---|---|---|---|---|
| | Example 1 | Example 2 | Example 3 | Example A | Example B |
| Basis Wt. (g/m²) | 50 | 44.1 | 48.5 | 45 | 50 |
| Air Permeability Frazier/Basis weight | 0.50 | 1.20 | 1.13 | 0.02 | 0.60 |
| (ft³/min-ft²)/(g/m²) | | | | | |
| MVTR/Basis weight (g/24 hrs/m²)/(g/m²) | 54.8 | 64.6 | 59.4 | 50.4 | 61.6 |
| (90° F./50% RH) | | | | | |
| Hydrostatic Head/Basic weight | 1.04 | 0.98 | 0.68 | 2.33 | 1.58 |
| (cm)/(g/m²) | | | | | |
| % Filtration Efficiency (0.5 mm) | 77 | 90.1 | 86 | NT | 70 |
| % Filtration Efficiency (0.3 mm) | 71 | 94 | 91 | NT | 67 |
| % Filtration Efficiency (0.1 mm) | 80.0 | 94.6 | 92 | NT | 80.0 |
| % Bacterial Filtration Efficiency (3.0 mm) | 94.0 | 99.1 | 91 | NT | 91.0 |

What is claimed is:

1. A nonwoven laminate barrier fabric, comprising
a) layer of SBS composite fabric,
b) a second layer of SBS composite fabric,
c) said layers bonded together to form a laminate fabric, and
d) said laminate fabric having an air permeability per basis weight ratio of at least about 1.0.

2. A nonwoven fabric as in claim 1, wherein said bonding is accomplished by thermal calendering, thermal point bonding, ultrasonic bonding, flat calendaring, and adhesive bond.

3. A nonwoven laminate barrier fabric comprising at least two SBS composite fabrics bonded together by thermal calendaring and having an air permeability per basis weight ratio of at least 1.0.

4. A nonwoven laminate barrier fabric as in claim 3, wherein said laminate is a protective garment.

5. A nonwoven laminate barrier fabric as in claim 3, wherein said laminate is an absorbent article component.

6. A nonwoven laminate barrier fabric as in claim 3, wherein said laminate is a surgical gown.
